(19) United States
(12) Patent Application Publication
(10) Pub. No.: US 2013/0198209 A1
(43) Pub. Date: Aug. 1, 2013

(54) MECHANISM AND INSTRUMENTATION FOR INTEREST DISCOVERY

(71) Applicant: Masood Mortazavi, San Jose, CA (US)

(72) Inventor: Masood Mortazavi, San Jose, CA (US)

(73) Assignee: YAHOO! INC., Sunnyvale, CA (US)

(21) Appl. No.: 13/363,813

(22) Filed: Feb. 1, 2012

(51) Int. Cl. G06F 17/30

(52) U.S. Cl. 707/754; 707/E17.059

(57) ABSTRACT

Systems and methods for interest discovery of users. First information related to activities of a user of a service is collected via the communication platform. Second information associated with the user is identified based on the first information in accordance with one or more predetermined scales. A request for a filter to be created is generated based on the second information. Data is filtered with the generated filter to identify events. The identified events are sent to a predetermined destination.

### BACKGROUND

1. Technical Field

The present teaching relates to methods, systems, and programming for interest discovery. Particularly, the present teaching is directed to methods, systems, and programming for delivering the interests of users in real-time with minimum processing power.

2. Discussion of Technical Background

The advancement in the world of the Internet has made it possible to make a tremendous amount of information accessible to users located anywhere in the world. With the explosion of information, new issues have arisen.

Social networking sites and news sites on the Internet attract hundreds of millions of users every month. The popularity of such sites depends on many factors. A factor is the ease-of-use of the site, which corresponds to the ability of a user to navigate the site, identify information and content relevant to the user. Another factor is the ability of the site to present or suggest content relevant to the user that the user did not search for. The more users a site has, the more potential the site has to generate revenue.

To aid users, companies and advertisers attempt to predict the interests of users. These predictions are used to place targeted advertisements in front of the users, and help the users of the website. The better the predictions of the interests of the users, the better will be the experience provided by the website to the users. Thus, the users will have a better experience with the website and the website will become more popular and generate more revenue. Poor predictions of the interests of the users cause frustration to the users and may cause the users to visit a different website. To produce accurate predictions, considerable processing power is required. This processing power is expensive, reducing the profitability and competitiveness of the web site.

### SUMMARY

The teachings disclosed herein relate to methods, systems, and programming for content processing. More particularly, the present teaching relates to methods, systems, and programming for finding the interests of users in real-time'with minimum processing power.

In one example, a method implemented on a machine having at least one processor, storage, and a communication platform connected to a network for real-time interest discovery is disclosed. First information related to activities of a user of a service is collected via the communication platform. Second information associated with the user is identified based on the first information in accordance with one or more predetermined scales. A request for a filter to be created is generated based on the second information. Data is filtered with the generated filter to identify events. The identified events are sent to a predetermined destination.

In another example, a method, implemented on a machine having at least one processor, storage, and a communication platform connected to a network for interest discovery is disclosed. First information related to activities of a user of a service provider is received from the service provider via the communication platform. Second information associated with the user is identified based on the first information in accordance with one or more predetermined scales. A second request for a filter to be created is generated based on a first request by the service provider and based on the second information. Data is filtered with the generated filter to identify events. The identified events are sent to the service provider.

In a different example, a system for interest discovery is disclosed. The system for real-time interest discovery comprises a first database, a second database, a recorder, a multi-scale analyzer, a streaming database, and a combiner. The recorder is connected to the first database, collects first information related to use by user and stores the first information in the first database. The multi-scale analyzer is connected to the first and the second database, identifies second information related to the user for one or more predetermined scales based on the first information in the first database, and stores the second information in the second database. The streaming database is connected to a communication platform and comprises a filter. The combiner is connected to the second database and builds a request for the filter based on one or more predetermined combinations of portions of the second information in the second database. The filter identifies events in data from the communication platform that correspond to the request from the combiner. The filter sends the identified events to a predetermined destination.

Other concepts relate to software for using the interests of users in real-time with minimum processing power. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine-readable tangible and non-transitory medium having information recorded thereon, wherein the information, when read by a machine, causes the machine to perform a method of interest discovery, is disclosed. First information related to activities of a user of a service is collected via the communication platform. Second information associated with the user is identified based on the first information in accordance with one or more predetermined scales. A request for a filter to be created is generated based on the second information. Data is filtered with the generated filter to identify events. The identified events are sent to a predetermined destination.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A and 1B depict examples of multi-scale analysis, according to an embodiment of the present teaching;

FIG. 2 is a high level depiction of an exemplary system in which identifying and using the interests of users in real-time is applied, according to a first application embodiment of the present teaching;

FIG. 3 is a high level depiction of an exemplary system in which identifying and using the interests of users in real-time is applied, according to a second application embodiment of the present teaching;

FIG. 4 depicts a system for identifying the interests of users in real-time, according to an embodiment of the present teaching;

FIG. 5 depicts a multi-scale analyzer, according to an embodiment of the present teaching;

FIG. 6 is a flowchart of an exemplary process, according to an embodiment of the present teaching;

FIG. 7 is a flowchart of an exemplary process, according to an embodiment of the present teaching; and

FIG. 8 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Many Internet based applications such as advertising and recommendation systems rely on almost real-time interest discovery. Various techniques such as multi-scale analysis, recent activity analysis, latent feature discovery, and explicit features of a user's activities or preferences can be used for interest analysis and discovery of users. Some of the analysis and discovery has to be done in real-time, because, for example, the user may only recently have performed an action, or a new subject of interest to a user may only recently have become news worthy. Much of the analysis and discovery can be performed ahead of time because the events happened long in the past. Moreover, much of this analysis need not be performed again because the results do not change.

The systems and methods disclosed divide the analysis and discovery into an off-line multi-scale analysis, and a high-speed analysis using a streaming database. The off-line multi-scale analysis is performed infrequently and with minimum resources. The results of the off-line multi-scale analysis are used to provide filter input to the streaming database. The filter input reduces the scope of streaming database queries thereby increasing the speed and reducing the computing power required for the queries.

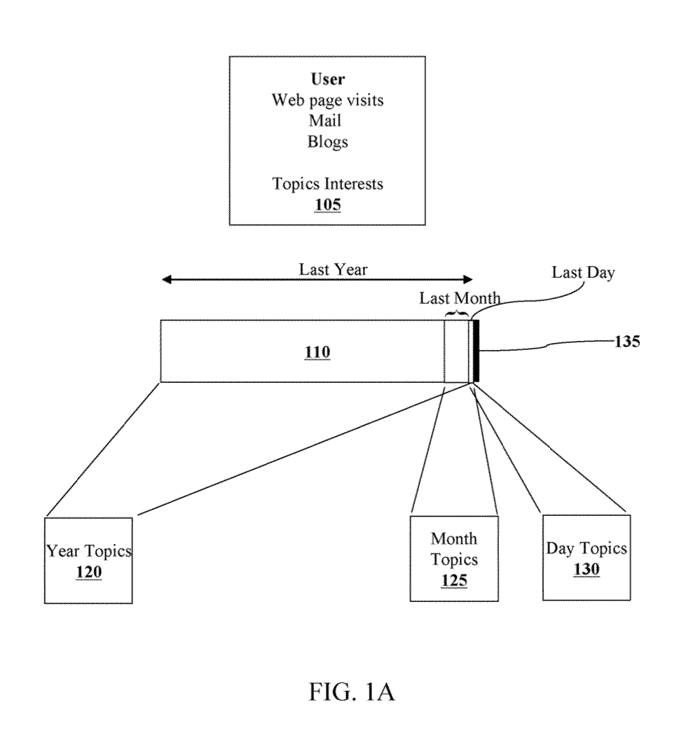

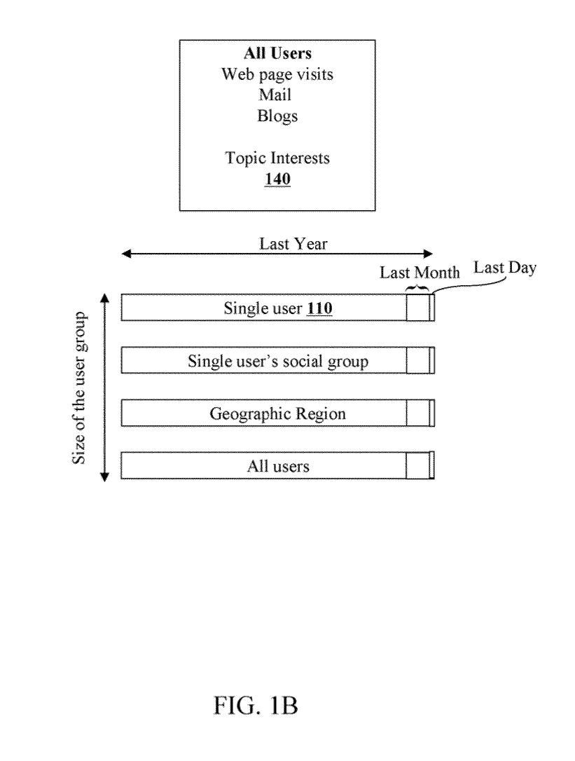

FIG. 1A illustrates an example of multi-scale analysis for a user, according to an embodiment of the present teaching. An interaction database 1105 for the user contains all of the Web page visits, email, messaging, and Blogs visited or posted by the user. The interaction database 105 for the user also contains known Topics of interest to the user based on explicit interests expressed by the user. The explicit interests may be obtained during a registration process performed by the user, from questions answered in surveys etc.

The interaction database can be analyzed over different periods of time to identify the interests of the user. The different periods of time represent different scales, making this a multi-scale analysis. Time chart 110 has periods of the last year, the last month, and the last day. However, any period of time compatible with embodiments of the disclosure is within the scope of this disclosure. Topics in interaction database 105 for the user are analyzed for the entire year of data and placed in a year topics database 120. Topics in interaction database 105 for the user are analyzed for the last month and placed in month topics database 125. The topics in interactions database for the user are analyzed for the last day and placed in the day topics database 130.

A particular portion of the multi-scale analysis is the very recent event 135, for example, an event such as a request for a web page. The very recent time frame includes events for which a decision for a response is advantageous in real-time. Real-time, for this application, means that there is not time to process information regarding other events before a response is required, but there is time to check that the event meets predetermined criteria. For example, an event 135 might include the user requesting a web page. The web page has to be delivered in less than about ¼ of a second to appear to be immediate to the user. This is enough time to compare the user with a list of users on a predetermined list, but is not sufficient time to compare the user's last one year of history with other users and the actions of those other users. One aspect of this application is thus to divide the multi-scale analysis into two portions. The first portion is the background multi-scale analysis portion that includes analyzing the events and interactions for users and entities over long periods of time. The periods of time may be, for example, one year, one month, or one day. The first portion produces data that identifies the associations and interactions for users. Further, the first portion produces data that identifies underlying topics of interest for the users. The associations and topics of interest can then be selected individually and combined to form predetermined criteria for identifying specific real-time events. The real-time identification of specific real-time events, based on the predetermined criteria forms the second portion of the multi-scale analysis. This second portion of the multi-scale analysis is performed in real-time.

In some embodiments, as noted above, the background multi-scale analysis identifies the topics of interest to users. The analysis used to identify the topics of interest, may include, for example, latent Dirichlet allocation, hierarchical Dirichlet processes, probabilistic latent semantic analysis, or Singular Value Decomposition of documents viewed or posted by the users, during the period of time. The above techniques analyze the words used by the user in the various documents posted or viewed by the user. Correlations in word use allow the above techniques to find topics the user is interested in, and the words associated with those topics. Such analysis produces the topic words and topics to be stored. Many of the topics stored in year topics database 120, month topics database 125, and day topics database 130 are the same. However, many of the topics will be different. For example, the user may have exhibited a great deal of interest in a first topic at the beginning of the year, but no interest recently. Therefore, the year topics database 120 might include the first topic, but the month and day topics databases 125, 130 would not include the first topic. Alternatively, the user might have exhibited a great deal of interest in a second topic, only in the last day. Therefore, the year topics database 120 and the month topics database 125 would not contain the second topic, but the day topics database 130 would contain the second topic.

The multi-scale analysis, thus, provides a more detailed indication of the interests of the user, because it allows, for example, a service provider, or an advertiser to distinguish a user that has a continuous, long-term interest in a particular topic compared with a user that has a short-term interest in the topic. Multi-scale analysis also allows changes in interest to be tracked. Multi-scale analysis can be based on any scale with a distance measure, for example, a “distance” between objects or events in time, space, social network, etc. In general, multi-scale analysis applies to any scale for which distance measures can be defined. Such distance measures may satisfy topological constraints, depending upon the topology of the space, such as the triangle rule in which distance(a,b)+distance(b,c)>=distance(a,c).

In some embodiments, as noted above, the background multi-scale analysis includes identifying relationships between users. The relationships include information such as, for example, whether a user on the team has sent e-mail, an instant message, an SMS message, or any other message to another user or entity. In another example, the relationship includes, whether a user has visited a website or webpage of a particular user or entity. Any other relationships between users and content that can be identified are within the scope of this disclosure. The above relationships can also be analyzed over different scales of time to determine, for example, whether the user has emailed a second user in the past year, month, or day.

FIG. 1B illustrates an example of multi-scale analysis for multiple users, according to an embodiment of the present teaching. An interaction database 140 for the users contains all of the Web page visits, email, messaging, and Blogs visited or posted by the users. The interaction database 140 for the user also contains known Topics of interest to the users. Techniques such as latent Dirichlet allocation, hierarchical Dirichlet processes, probabilistic latent semantic analysis, or Singular Value Decomposition of the text of documents viewed or posted by the users perform better, when used simultaneously on a large number of users. These techniques perform better with a large number of users because, although a first user may refer to a first topic briefly, a large number of users may refer to the first topic numerous times. This allows the topics to be identified with greater accuracy, and the words associated with those topics to be identified with greater accuracy. However, the number and type of users included in the analysis will change the topics and the words that are identified.

The analysis for the user time chart 110 is shown in FIG. 1B. FIG. 1B also shows the analysis for the user's social group, for the single-user's geographic region and for all users. These different groups of users correspond to a scale on which to analyze the relationships and interests of users. Each of these groups can be analyzed over different time scales as discussed above. Thus, a multi-scale analysis can be performed over two variables, time and type of user group. The multi-scale analysis can be extended to include other scales based on, for example, demographics, topics of interest, or any other scales compatible with embodiments of the disclosure.

If the topic of interest analysis is restricted to the user in FIG. 1, the only topics that can be distinguished from the documents of the user will appear in the topic databases. For example, the user might not be interested in politics, and candidates for an election might not appear as topics of interest to the user. If the analysis is extended to the user and the user's social group then topics will be identified for the users in the social group as a whole. Based on the topics identified for the users in the social group more topics will also be identified for the user. For example, the user's social group might all be members of the Democratic Party. Therefore, Democratic Party candidates may appear as topics. Although the user mentions Democratic Party candidates infrequently, these candidates may now become recognized as topics of interest to the user. Thus, the topics identified from an analysis of the social group will be limited to the topics discussed by the social group, but the topics will be focused in a few areas. If the analysis is extended to the user, and the user's geographic region, for example, a particular town, city, state or country, a completely different group of topics may be identified. For example, the user's social group may be distributed across the United States, but the user may live in New York City. Thus, the analysis of the user's geographic region might not produce Democratic Party candidates as topics, but may produce candidates for election in New York City as topics. If the analysis is extended to all users, neither specific Democratic or New York City candidates may appear as topics, however, presidential candidates may appear as topics. Thus, depending on the scale of users included in the analysis, different topics will appear.

In a similar manner, identifying relationships between users can also be applied over different scales of users. For example, many of the users in the user's social group might visit a particular website regularly. However, a geographic group of users may only infrequently visit the same websites. The social group of users will likely have strong relationships regarding sending of e-mail to one another. The geographic group may have weak, relationships regarding sending of e-mail to one another.

Advertisers and service providers can use these multi-scale analyses in time, number of users, and location of users to target advertising and content. For example, an advertiser for a product in New York City may only wish to know the interests of users in New York City. That same advertiser may only wish to know the interests of users in the last month. Thus, by choosing results from appropriate parts of the multi-scale analysis, the advertiser can select the users and the opinion of only those users. Further, the advertiser may wish to target web advertising only for the above users when the users perform an action at a service provider related to their product. For example, if the advertisement is for car insurance in New York City, the advertiser may wish to target users in New York City that drive a car, but only at the moment that each user views websites related to buying a new car. Information indicating that the user drives the car may become apparent in a one-year analysis of the user, but may not be apparent in the last month or the last day. Therefore, the advertiser would pick a geographic location of New York City and topics from last year. Users that meet these criteria can then be monitored for an action indicating the user intends to purchase a new car.

The multi-scale analysis discussed above need only be carried out intermittently. However, monitoring users for particular activity has to be performed continuously. Using the results of multi-scale analysis to reduce the number of users that need to be monitored for a particular activity decreases the computing power required to perform the monitoring. This reduces the cost, or increases the capability of the currently available equipment. Such a system to provide real-time interests of users can provide, therefore, real-time interests of users at low cost with great accuracy.

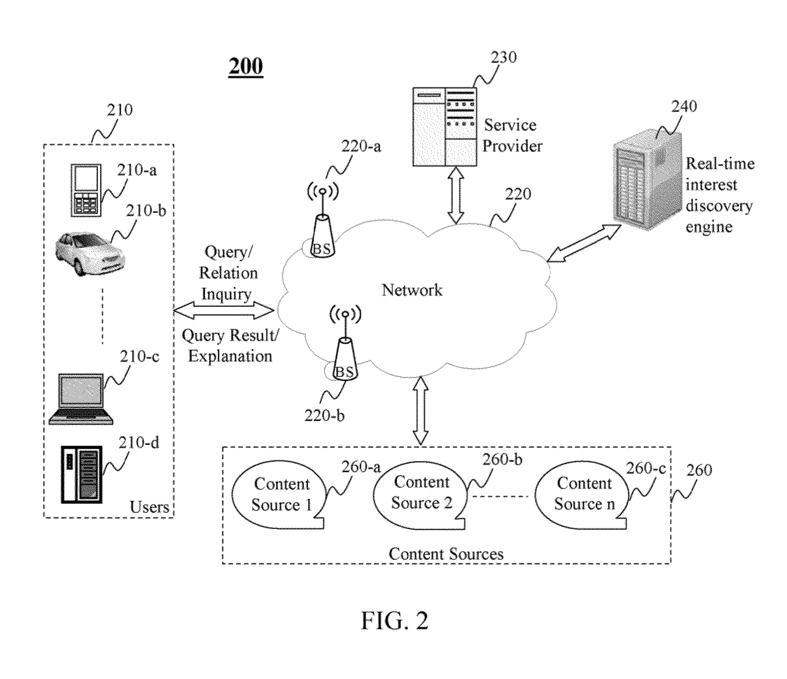

FIG. 2 is a high-level depiction of an exemplary system 200 in which a real-time interest discovery engine 240 is deployed to provide real-time interests of users according to a first application embodiment of the present teaching. The exemplary system 200 includes users 210, a network 220, a service provider 230, content sources 260, and a real-time interest discovery engine 240. The network 220 in system 200 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, for example, wired or wireless access points such as base stations or Internet exchange points 220-a, . . . , 220-b, through which a data source may connect to the network in order to transmit information via the network.

Users 210 may be of different types such as users connected to the network via desktop connections (210-d), users connecting to the network via wireless connections such as through a laptop (210-c), a handheld device (210-a), or a built-in device in a motor vehicle (210-b). A user may send a request to the service provider 230 via the network 220 and receive content related to the request from the service provider 230 through the network 220. The request is also sent to the network 220 and is directed to the real-time interest discovery engine 240, which will analyze the information available, e.g., content sources 260, to derive the real-time interests of users. The real-time interests are then sent from the real-time interest discovery engine 240 to the service provider 230 via the network 220.

The content sources 260 include multiple content sources 260a, 260b, . . . , 260c. A content source may correspond to a web page host corresponding to an entity, whether an individual, a business, or an organization such as USPTO.gov, a content provider such as cnn.com and Yahoo.com, or a content feed source such as tweeter or blogs. Both the service provider 230 and the real-time interest discovery engine 240 may access information from any of the content sources 260a, 260b, . . . , 260c and rely on such information to respond to a request (e.g., the service provider 230 identifies content related to the request and returns the content to the user).

In the exemplary system 200, a user may initially send a request for content to the service provider 230 to obtain content to some embodiments, the request may be first sent to the service provider 230 and then re-directed to the real-time interest discovery engine 240, if the service provider 230 operator contracts with the operator of the real-time interest discovery engine 240. In such a configuration, the real-time interests output from the real-time interest discovery engine 240 may be sent back to the service provider 230 so that they can be used by the service provider to customize the response to the user. Alternatively, the real-time interest discovery engine 240 may return a customized response to the request directly back to the user, if the user's information is, e.g., forwarded to the real-time interest discovery engine 240 when the request is re-directed.

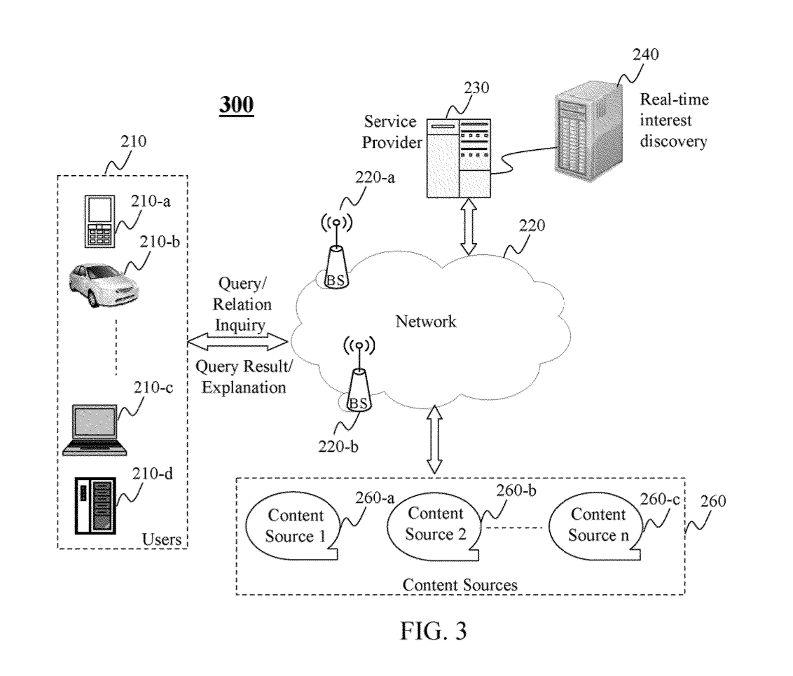

FIG. 3 is a high-level depiction of an exemplary system 300 in which the real-time interest discovery engine is deployed to provide real-time interests, according to a second application embodiment of the present teaching. In this embodiment, the real-time interest discovery engine 240 serves as a backend system of the service provider 230. All requests for content are sent to the service provider 230, which then invokes the real-time interest discovery engine 240 to determine the real-time interests of users.

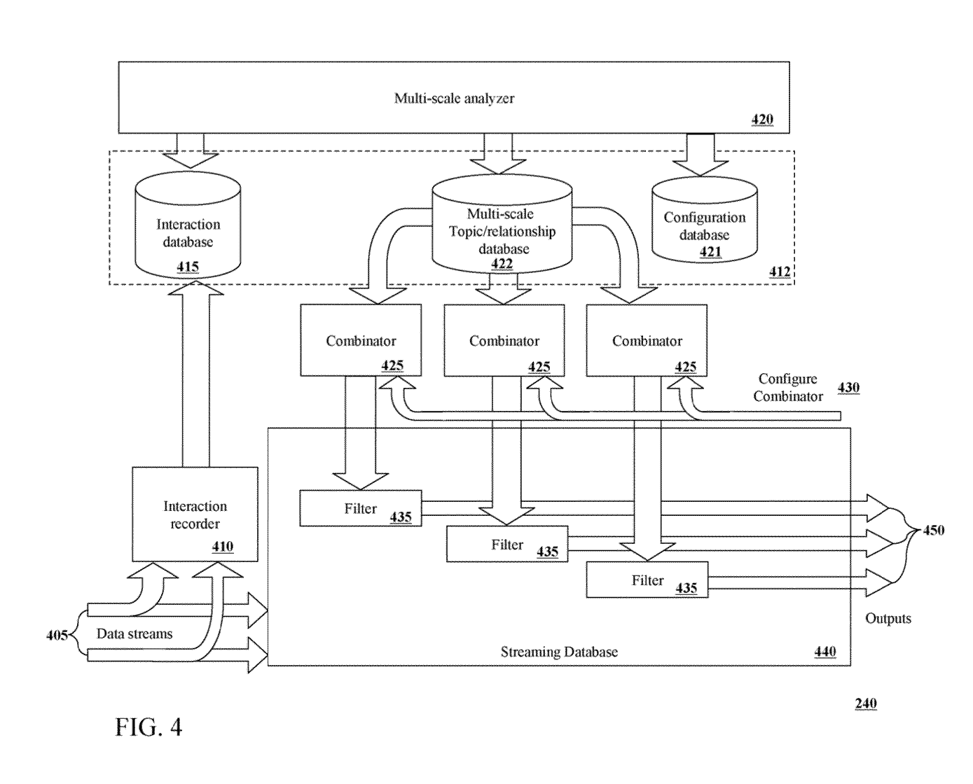

FIG. 4 depicts real-time interest discovery engine 240 for identifying the interests of users in real-time, according to an embodiment of the present teaching. The system 400 comprises a streaming database 440 connected to data streams 405, an interaction recorder 410, an interaction database 415, a multi-scale analyzer 420, and one or more combiners 425.

The streaming database 440 comprises filters 435. Each filter 435 corresponds to one of the combiners 425.

The data streams 405 include, for example, Internet traffic, e-mail traffic, SMS data, or any other data flowing through a network. The network may be a private network, a public network, or the Internet. The data streams 405 maybe traffic flowing to and from a website.

An interaction recorder 410 records activity on the data streams 405, and stores the activity in an interaction database 415. In some embodiments, the interaction recorder identifies users based on IP addresses, cookies, or any other method compatible with embodiments of the disclosure. In some embodiments, the interaction recorder records activities for users in separate portions of interaction database 415 corresponding to each user. In some embodiments, the interaction recorder records the time and date of each activity. In some embodiments, the interaction database 415 is a portion of a larger database 412. In other embodiments, the interaction database 415 is a standalone database.

A multi-scale analyzer 420 periodically analyzes the interaction database using techniques such as, for example, latent allocation, hierarchical Dirichlet processes, probabilistic latent semantic analysis, or Singular Value Decomposition to identify the interests and relationships of users over, for example, particular time scales or groups of users. The multi-scale analyzer 420 stores the topics and relationships identified, along with the scale of the topics and relationships identified in the multi-scale topic/relationship database 422. In some embodiments, the multi-scale topic/relationship database 422 is a portion of the larger database 412. In some embodiments, the multi-scale topic/relationship database 422 is a standalone database. A configuration database 421 is used to configure the multi-scale analyzer 420. The configuration database 421 includes configuration data for the multi-scale analyzer 420. The configuration data configures for example, the period over which to identify interactions in the interaction database, groups of users for which to identify interactions, or any other criteria for selecting interactions from the interaction database compatible with embodiments of the disclosure.

One or more combiners 425 access the topics and relationships in the multi-scale topic/relationship database 422. The combiners 425 can be configured to combine results from the different scales of the multi-scale analyzer. For example, a combiner 425 can be configured to identify users from New York City that appear to have driven a car for the last year. In a second example, the, combiner 425 can be configured to identify users that over the last year have been interested in playing computer games, and in the last month have become interested in a particular computer game. The combiner 425 may be configured to search for any combination of topics and/or relationships of interest in any of the different aspects of the multi-scale analysis. In some embodiments, a third party to the operator of the system 400 for identifying the real-time interests of users is able to program independently a combiner 425 for the third party's use. For example, the third party may be an advertising agency that wishes to program a combiner 425 for targeted advertising.

In some embodiments, the combiners 425 are also configured with targets to search for in the data stream 405. The targets include, for example, +requests for specific content, requests for a type of content, keywords, or phrases in any requests or content, emails or messages sent to particular people or organizations, or any other targets compatible with embodiments of the disclosure.

In some embodiments, the combiners are also configured with information indicating the party interested in the results of the request. The information indicating the party interested in the results of the request may be in the form of an identity of a database and the location of the database, an IP address, an email address, or any other information allowing the party interested in the results to receive the results. The combiners can be configured using a data input 430.

Based on the programming of the combiner, the combiner constructs a search request for a corresponding filter 435 of the streaming database 440. The search request may be constructed using a similar language to Structured Query Language (SQL) specifically developed for streaming databases.

The outputs of the combiners 425 are sent to the corresponding filters 435 in streaming database 440. In some embodiments, the streaming database 440 is replaced by, for example, a packet filter comprising appropriate filters. In some embodiments, any filter that is capable of filtering the data streams 405 and compatible with embodiments of the disclosure is within the scope of the disclosure. The filters 435 filter the streaming data 405 based on the outputs from the combiners 425. When an action matches the action that the filter 435 is requested to identify, and the action is for a user that meets the requirements specified by the corresponding combiner 425, the filter outputs the user and the action as a data stream to the interested party. The outputs from the filters 435 are fed the party interested in the events via outputs 450. In some embodiments, the outputs 450 are connected to a network connected to the interested party. In some embodiments, the outputs 450 are connected to the Internet.

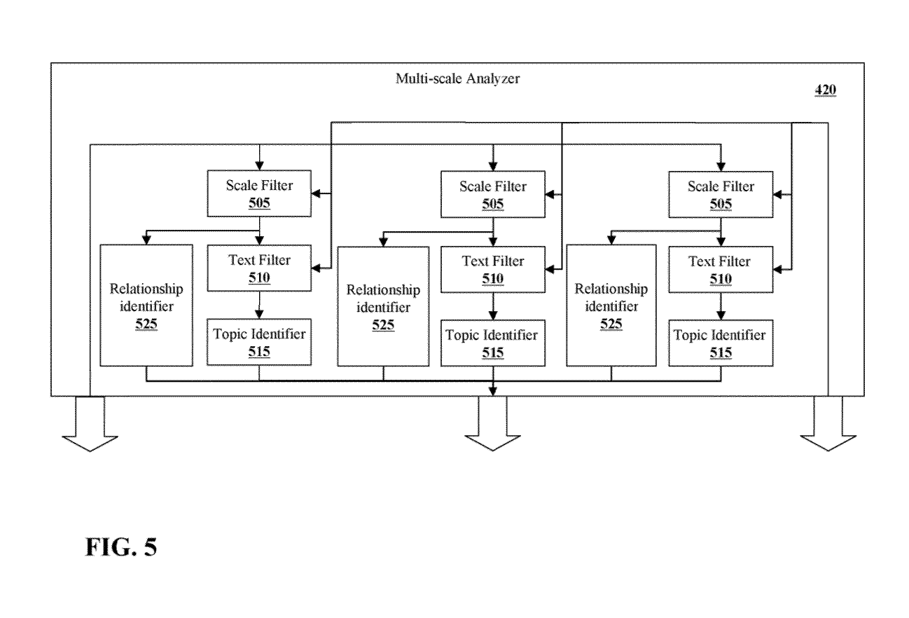

FIG. 5 depicts a topic/relationship multi-scale analyzer 420, according to an embodiment of the present teaching. Multi-scale analyzer 420 comprises scale filters 505, text filters 510, topic identifiers 515, and relationship identifiers 525

The scale filters 505 access an interaction database, for example, interaction database 415. The scale filters 505 are connected to the configuration database 421. The scale filters 505 filter the interactions and documents that fulfill the criteria in the configuration database 421. The criteria include time scale criteria and user scale criteria. The scale filters 505 forward the interactions and documents meeting the criteria to corresponding text filters 510 and corresponding relationship identifiers 525.

The text filters 510 filter words and text in the forwarded interactions and documents to remove features that are not relevant to discovering topics of interest. For example, in some embodiments, the text filters 510 may remove audio, images, video, and other streaming data. In some embodiments, the text filters 510 may convert audio, images, video, and other streaming data into text using image recognition and/or speech recognition techniques. In some embodiments, the text filters 510 remove formatting characters, formatting strings, HTML, or XML tags. In some embodiments, the text filters 510 remove “stop words” such as and, or, if, a, and the. In some embodiments, the text filters remove punctuation. The text filters 510 are connected to the configuration database 421. The text fitters 510 filter the text in the forwarded interactions and documents according to configurations in the configuration database 421.

The text filtered interactions and documents are forwarded to corresponding topic identifiers 515. The topic identifiers 515 identify topics of interest to the users in the interactions and documents based on techniques such as latent Dirichlet allocation, hierarchical Dirichlet processes, probabilistic latent semantic analysis, or Singular Value Decomposition, as discussed above, or any other techniques compatible with embodiments of the disclosure. The topic identifiers 515 store the results in a database, for example, multi-scale topic/relationship database 422 accessible by the combiners.

The relationship identifiers 525 receive the interactions of documents meeting the time scale criteria and the user scale criteria. The relationship identifiers 525 process the interactions and documents to identify relationships between users, entities, and documents. The relationship identifiers 525 store the results of processing in a database, for example, multi-scale topic/relationship database 422 accessible by the combiners.

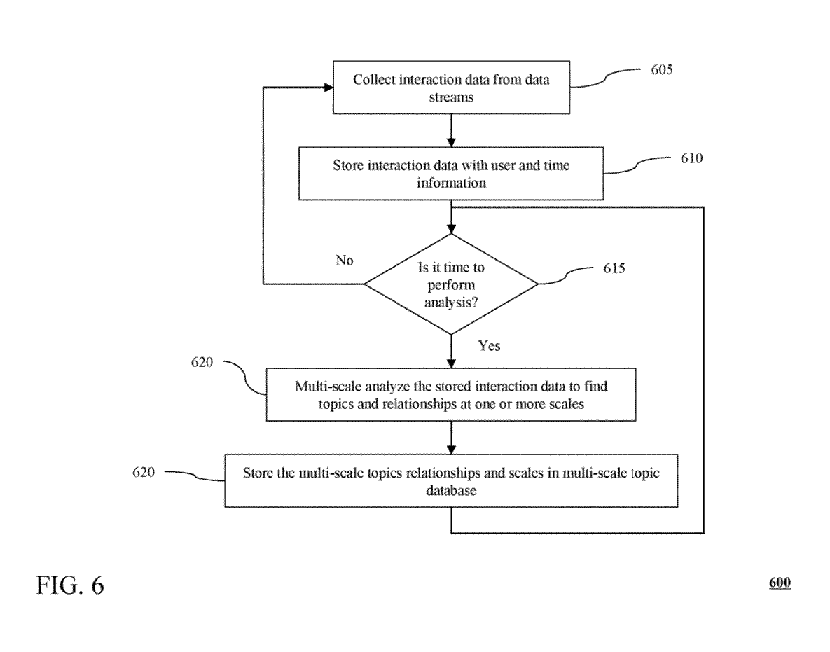

FIG. 6 depicts a method 600 for performing multi-scale analysis, according to an embodiment of the present teaching. At step 605, interaction data from data streams is fed to the system for identifying interests of users in real-time. The system for identifying interests of users is, for example, real-time interest discovery engine 240, as discussed above. The system collects interaction data and documents from the data streams. The interaction data and documents comprise documents viewed or posted by users interacting with a particular service provider or group of service providers. The service provider or group of service providers can be on an internal network or the Internet.

At step 610, the interaction data and documents are stored in the interaction database 415. In some embodiments, each piece of the interaction data or document is stored so that a user associated with interaction data or a document can be identified. In some embodiments, the interaction data or document is stored in a portion of the interaction database 415 corresponding to the user. In some embodiments, the interaction data or document is stored along with an indication of the associated user. In some embodiments, the interaction data or document is stored along with a time and date of the interaction. In some embodiments, the interaction data or document is stored in a portion of the database corresponding to a particular date and time. In some embodiments, any other data relevant to the interaction data or document and compatible with embodiments of the disclosure can be stored along with the interaction data or document.

At step 615, a decision is made regarding whether it is time to perform a multi-scale analysis on the data collected. In some embodiments, the decision is based on the quantity of data collected since the last multi-scale analysis. In some embodiments, the decision is based on a time elapsed since the last multi-scale analysis. In some embodiments, the decision is based on input from an operator. If it is decided not to perform a multi-scale analysis of interaction data or documents collected, the method proceeds to step 605 to collect more interaction data if it is decided to perform a multi-scale analysis, the method proceeds to step 620.

In some embodiments, the system for discovering real-time interests does not stop collecting interaction data or documents when a decision is made to perform a multi-scale analysis. In some embodiments, while the multi-scale analysis is proceeding, newly collected interaction data or documents are stored in a separate database until the multi-scale analysis is complete. In some embodiments, newly collected interaction data or documents are stored in the same interaction database, but labeled as not to be used by the multi-scale analysis. In some embodiments, the newly collected interaction data or documents are added to the same database and the multi-scale analysis incorporates the newly collected data as the data is added.

At step 620, a multi-scale analysis of the interaction data is performed. In some embodiments, the multi-scale analyzer 420 can be configured to perform the multi-scale analysis on different scales of time, for example, one year, one month, one week, one day, one hour, etc. The periods of time may not be the most recent period of time. For example, a separate analysis may be performed for each day in the last week, or a separate analysis may be performed for each Monday in the last year. Alternatively, an analysis might be performed, that includes the interaction data from every Sunday in the last year. In some embodiments, any set of time periods either contiguous or noncontiguous, of equal or unequal lengths is within the scope of embodiments of the disclosure.

The multi-scale analyzer 420 can be configured to analyze on different scales of type of users. For example, multi-scale analysis can analyze a set of social groups of users, sets of geographically related users, sets of culturally related users, or any other group of users that can be distinguished in some manner.

The multi-scale analyzer 420 can also be configured to analyze on different scales of content accessed or posted by users. For example, the multi-scale analyzer 420 can be configured to analyze e-mail containing a particular subject. In another example, the multi-scale analyzer 420 can be configured to analyze interactions with a particular website. In some embodiments, any manner of selecting interaction data for a portion of the multi-scale analysis is within the scope of this disclosure.

In some embodiments, the multi-scale analysis identifies the topics of interest to users, using, for example, latent Dirichlet allocation, hierarchical Dirichlet processes, probabilistic latent semantic analysis, Singular Value Decomposition, or any other technique compatible with embodiments of the disclosure. In some embodiments, the multi-scale analysis identifies the relationships between users and content.

At step 625, the results of the multi-scale analysis are stored in the multi-scale topic/relationship database 422. The results of the analysis include topics and relationships corresponding to interactions and documents analyzed in each of the scales of the multi-scale analysis. In some embodiments, the scale of the analysis is stored along with each of the topics and relationships. In some embodiments, topics associated with a particular scale are stored in a portion of the multi-scale topic/relationship database 422 corresponding to the scale. When the results of the multi-scale analysis have been stored, the method proceeds to step 615 to determine whether the multi-scale analysis should be repeated.

In some embodiments, the decision step 615 may be performed multiple times for multiple different scales. For example, a decision may be made to analyze at a scale of one week, but to postpone an analysis at the scale of one year. Alternatively, a decision may be made to analyze scales for different groups of users, but postpone an analysis of different timescales.

In some embodiments, the results of a previous multi-scale analysis can be added to the results of a newly completed multi-scale analysis. For example, results from multi-scale analysis for each of the last 12 months may be processed to generate a known scale analysis for the last year, rather than performing a multi-scale analysis for the last year. In some embodiments, any combination of scales in the multi-scale analysis may be combined to form a new portion of a multi-scale analysis.

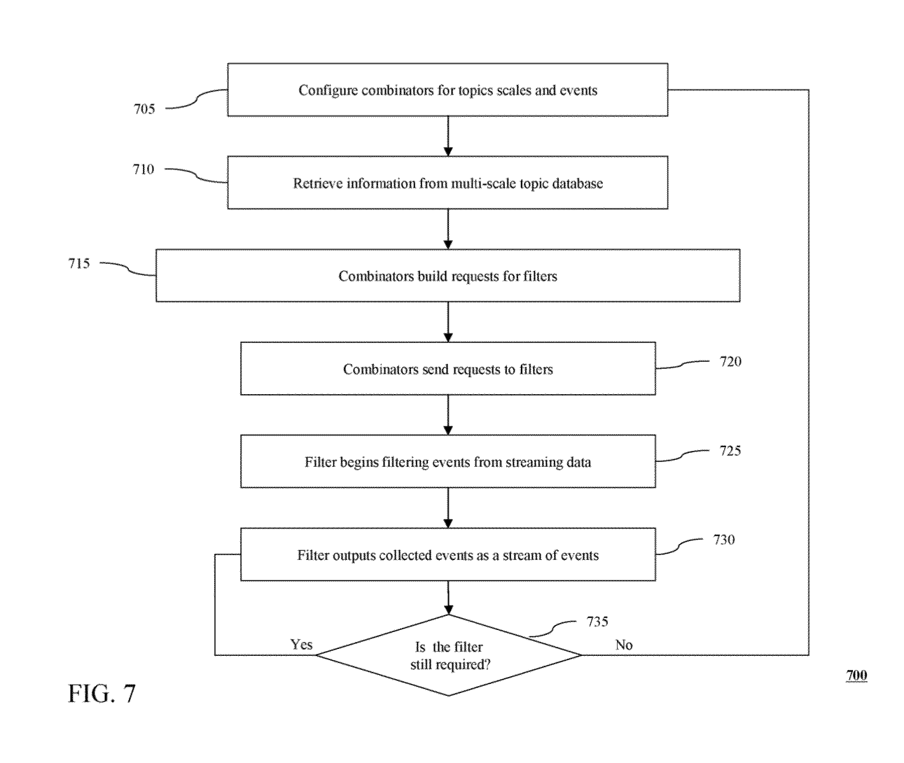

FIG. 7 depicts a method 700 for identifying the interests of users in real-time, according to an embodiment of the present teaching. At step 705, combiners 425 are configured to select combinations of scales, topics, relationships, and events. The scales may include, for example, timescales and user scales as discussed above. For example, a combiner 425 may be configured to identify the users interested in a particular car in the last year, and interested in green issues in the last month. The combiner may be further configured to search for events including requesting content from websites for new cars. This combiner would allow advertisers to target, for example, people interested in an expensive model of car, that recently became interested in green issues and appear to be about to purchase a car.

Alternatively, a combiner 425 might be configured to identify the content that includes a reference to solar power, and was accessed by large numbers of users in the last month. The combiner 425 may be further configured to search for the event of a user accessing the above content and providing the identity of the user. An advertiser would then be able to compile a list of potential clients for a solar power system that have viewed a competitor's website.

In some embodiments, the combiners 425 are configured by the owner of the system 240 directly. In some embodiments, the owner of the real-time interest system 240 might sell or lease combiners 425 to third parties to be configured as a third party wished. The third party may also configure the combiners 425 to stream the results of any real-time interest search directly to the third party.

In some embodiments, the combiners 425 are configured by sending a text file to the combiners 425 detailing the configuration. In some embodiments, a binary file is sent to the combiner 425 detailing the configuration. In some embodiments, the entity configuring the combiner 425 uses a menu driven system provided by the operator of the real-time interest system 240. The menu-driven system may be provided with a list of all of the topics, scales, and events available for configuration. The entity configuring the combiner can use drop-down menus in the menu-driven system for configuration. The drop-down menus may include lists of the topics/relationships scales and events available for configuration. The menu-driven system may further include drop-down menus for operators that link different topics scales and events. For example, a first drop-down menu might include a list of topics. A second drop-down menu might include an operator such as AND, OR, <, >, =, NOT etc. A third menu might include a drop-down menu of scales, or topics or events. Using such a menu system the entity configuring the combiner 425 may easily configure complex queries for the real-time interest system 240.

In some embodiments, the combiners 425 are also configured with information indicating the party interested in the results of the request. The information indicating the party interested in the results of the request may be in the form of an identity of a database and the location of the database, an IP address, an email address, or any other information allowing the party interested in the results to receive the results combiner

At step 715, the combiner 425 build requests for the filters 435 of the streaming database 440. If, for example, the combiner 425 is configured to search for users interested in a particular topic in a particular time frame, then the combiner 425 queries the multi-scale topic/relationship database 422 for those users. If, for example, the combiner 425 is configured to search for content about particular topics, the combiner 425 queries the multi-scale topic database 422 for the content about the topics. The combiner builds a request based on the query to the multi-scale topic database 422 and an optional event that the combiner is configured to identify. The request may be constructed in a query language, for example, SQL. In some embodiments, any language for constructing a request or method of constructing a request is within the scope of the disclosure

At step 720, the combiner sends the request to a filter 435 of the streaming database 440.

At step 725, the filter begins filtering the data streams 405 to collect events corresponding to the request.

At step 730, the filter 435 streams the collected event to the entity that configured the corresponding combiner 425. In some embodiments, at step 730, the filter 435 streams a fixed number of events before proceeding to step 735. In some embodiments, the filter 435 proceeds to step 735, based on a new request from the corresponding combiner 425. In some embodiments, the filter 435 proceeds to step 735, based on an interrupt.

At step 735, the filter 435 checks whether the filter 435 is still required. If the filter 435 is still required, the method repeats from step 730. If the filter 435 is no longer required, the method repeats from step 705.

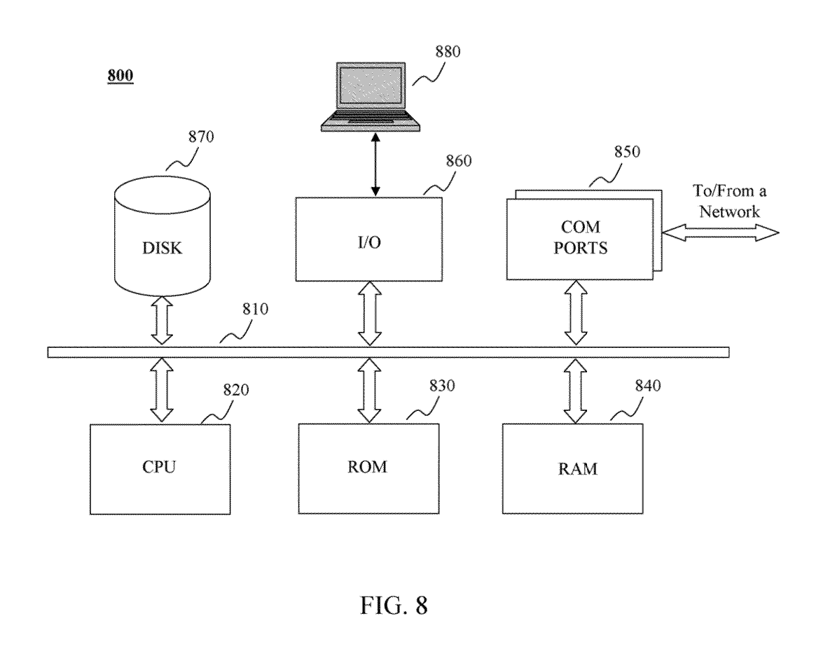

FIG. 8 depicts a general computer architecture on which the present teaching can be implemented and has a functional block diagram illustration of a computer hardware platform which includes user interface elements. The computer may be a general-purpose computer or a special purpose computer. This computer 800 can be used to implement any components of the interest discovery as described herein. For example, the multi-scale analyzer 420, the streaming database 440, the interaction recorder 410, the interaction database 415, and the combiners 425 can be implemented on a computer such as computer 800, via its hardware, software program, firmware, or a combination thereof. Although only one such computer is shown, for convenience, the computer functions relating to interest discovery may be implemented in a distributed fashion on a number of similar platforms, to distribute the processing load.

The computer 800, for example, includes COM ports 850 connected to and from a network connected thereto to facilitate data communications. The computer 800 also includes a central processing unit (CPU) 820, in the form of one or more processors, for executing program instructions. The exemplary computer platform includes an internal communication bus 810, program storage and data storage of different forms, e.g., disk 870, read only memory (ROM) 830, or random access memory (RAM) 840, for various data files to be processed and/or communicated by the computer, as well as possibly program instructions to be executed by the CPU. The computer 800 also includes an I/O component 860, supporting input/output flows between the computer and other components therein such as user interface elements 880. The computer 800 may also receive programming and data via network communications.

Hence, aspects of the methods of interest discovery, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the service provider operator or other interest discovery engine into the hardware platform(s) of a computing environment or other system implementing a computing environment or similar functionalities in connection with discovering user interests. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium, or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore, include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the interest discovery system components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

We claim:

1. A method implemented on a machine having at least one processor, storage, and a communication platform connected to a network for real-time interest discovery comprising:
collecting, via the communication platform, first information related to activities of a user of a service;
identifying second information associated with the user based on the first information in accordance with one or more predetermined scales;
generating a request for a filter to be created based on the second information;
filtering, with the generated filter, data to identify events; and
sending the identified events to a predetermined destination.

2. The method of claim 1, wherein the one or more predetermined scales correspond to one or more periods of time, location, or groups of users.

3. The method of claim 1, wherein the request for the filter is further based on a predetermined type of event and further comprising identifying, with the filter, events in streaming data corresponding to the predetermined type of event.

4. The method of claim 1, wherein identifying the second information further comprises:
selecting relevant information from among the first information for each of the one or more predetermined scales; and
identifying the second information based on the corresponding relevant information.

5. The method of claim 4, further comprising:
filtering the corresponding relevant information to remove items unlikely to identify topics of interest of the user to form filtered relevant information; and
identifying the second information based on the filtered relevant information.

6. A method, implemented on a machine having at least one processor, storage, and a communication platform connected to a network for real-time interest discovery, comprising the steps of:
receiving, from a service provider, first information related to activities of a user of the service provider, via the communication platform;
identifying second information associated with the user based on the first information in accordance with one or more predetermined scales;
generating, based on a first request by the service provider, a second request for a filter to be created based on the second information;
filtering, with the generated filter, data to identify events; and
sending the identified events to the service provider.

7. The method of claim 6, wherein the one or more predetermined scales correspond to one or more of periods of time, location, or groups of users.

8. The method of claim 6, wherein the request for the filter is further based on a predetermined type of event and further comprising identifying, with the filter, events in streaming data corresponding to the predetermined type of event.

9. The method of claim 6, wherein identifying the second information further comprises:
selecting relevant information from among the first information for each of the one or more predetermined scales; and
identifying the second information based on the corresponding relevant information.

10. The method of claim 9, further comprising:
filtering the corresponding relevant information to remove items unlikely to identify topics of interest of the user, to form filtered relevant information; and
identifying the second information based on the filtered relevant information.

11. A machine-readable tangible and non-transitory medium having information recorded thereon, wherein the information, when read by a machine, causes the machine to perform a method of interest discovery compromising:
collecting, via a communication platform, first information related to activities of a user of a service;
identifying second information associated with the user based on the first information in accordance with one or more predetermined scales;
generating a request for a filter to be created based on the second information;
filtering, with the generated filter, data to identify events ; and
sending the identified events to a predetermined location.

12. The machine-readable tangible and non-transitory medium of claim 11, wherein the one or more predetermined scales correspond to one or more of periods of time, location, or groups of users.

13. The machine-readable tangible and non-transitory medium of claim 11, wherein the request for the filter is further based on a predetermined type of event and the method further comprising identifying, with the filter, events in streaming data corresponding to the predetermined type of event.

14. The machine-readable tangible and non-transitory medium of claim 11, wherein identifying the second information further comprises:
selecting relevant information from among the first information for each of the predetermined scales; and
identifying the second information based on the corresponding relevant information.

15. The machine-readable tangible and non-transitory medium of claim 14, further comprising:
filtering the corresponding relevant information to remove items unlikely to identify topics of interest of the user to form filtered relevant information; and
identifying the second information based on the filtered relevant information.

16. A system for interest discovery comprising:
a first database;
a recorder, connected to the first database, that collects first information related to use by user and stores the first information in the first database;
a second database;
a multi-scale analyzer, connected to the first and the second database, that identifies second information related to the user for one or more predetermined scales based on the first information in the first database, and stores the second information in the second database;
a streaming database connected to a communication platform, the streaming database comprising a filter; and
a combiner connected to the second database that builds a request for the filter based on one or more predetermined combinations of portions of the second information in the second database;
wherein
the filter identifies events in data from the communication platform that correspond to the request from the combiner, and
the filter sends the identified events to a predetermined destination.

17. The system according to claim 16, the multi-scale analyzer further comprising one or more scale filters that filter the first information in the first database based on the one or more predetermined scales to form sets of relevant information, each set of relevant information corresponding to one of the one or more predetermined scales.

18. The system according to claim 17, the multi-scale analyzer further comprising one or more relationship identifiers, each relationship identifier connected to a corresponding one of the scale filters, the relationship identifiers identifying the relationships between the user and other users based on the set of relevant information from the corresponding scale filter.

19. The system according to claim 17, the multi-scale analyzer further comprising one or more text filters, each text filter connected to a corresponding one of the scale filters, the text filters filtering a corresponding set of relevant information to form a set of words likely to indicate topics of interest to the user.

20. The system according to claim 19, the multi-scale analyzer further comprising topic identifiers, each topic identifier connected to a corresponding one of the one or more scales filters, the topic identifiers identifying the topics of interest of the user for the corresponding scale based on the set of relevant information.
